(19) United States
(12) Patent Application Publication
(10) Pub. No.: US 2009/0069954 A1
(43) Pub. Date: Mar. 12, 2009

(54) CONTROL AND SYSTEM NOTIFICATIONS USING REMOTE ACCESS

(75) Inventor: Kayode ALADESUYI, Acworth, GA (US)

Correspondence Address: GREENBLUM & BERNSTEIN, P.L.C., 1950 ROLAND CLARKE PLACE, RESTON, VA, 20191, US

(73) Assignee: EarthSearch Communications, Inc., Marietta, GA (US)

(21) Appl. No.: 11/854,305

(22) Filed: Sep. 12, 2007

(51) Int. Cl. B60K 28/10

(52) U.S. Cl. 701/2

(57) ABSTRACT

The present system provides a method to allow vehicle users to locate, monitor, and control their vehicle and receive notifications of constraint violations by using a hand-held device and/or internet web browser. Such constraints may be customized by vehicle or group of vehicles, over the air or by a user using a host. In the case of constraint notifications, the vehicle device receives and processes vehicle data and constraint data and sends this information to the host. In the case of vehicle location, monitoring and/or control, the host receives the solicitation and sends an instruction to the vehicle device, the vehicle device will receive and process the instruction and interact with the vehicle accordingly.

### BACKGROUND OF THE DISCLOSURE

1. Field of the Invention

The present disclosure relates to the field of telecommunications. More particularly, the present disclosure relates to a communications and control system, an apparatus, a method and a computer program for locating, controlling, configuring, and communicating with a vehicular system.

2. Background of the Disclosure

Technology has progressed at near exponential levels. Like many areas, the technology implemented in vehicles has vastly progressed, offering users many unprecedented amenities. Many vehicles include amenities such as, for example, a security system, a remote keyless entry system, and a remote start system. Some of the amenities have been coupled to communication systems to enable users to remotely operate, for example, the security system, the remote keyless entry system, and the remote start system in a vehicle. Typically, the communication systems include a unidirectional hand-held transmitter device and a unidirectional vehicle-mounted receiver device.

Generally, the hand-held transmitter device is a dedicated device that is only useable to activate/deactivate the security system, control the keyless entry system, and/or remotely start the vehicle. The transmitter device includes a low-power radio frequency (RF) transmitter and has a limited range of operation, such as, for example a sixty-foot radius from the receiver device. The transmitter device is unable to receive or relay complex commands to the receiver device.

The receiver device of the typical communications system includes an RF receiver and is capable of receiving a limited number of command signals. The more comprehensive receiver devices may be capable of receiving command signals from the transmitter device to lock/unlock the doors, open/close the windows, arm/disarm the security system, enable/disable the security system, open/close the tailgate, and/or remotely start the engine on a vehicle. However, the receivers are unable to receive more complex commands.

A need exists for a transceiver system, apparatus, method, and computer program that is not limited by a physical distance between a transmitter and receiver pair, and that provides a user with an ability to remotely perform complex functions using, for example, a hand-held apparatus.

### SUMMARY OF THE DISCLOSURE

According to an aspect of the disclosure, a system for implementing remote communications with a vehicle is provided. The system includes a user apparatus and a host. The user apparatus comprises a communication interface configured to communicate with the host over a network and to receive a computer code section from the host, a memory configured to store the received computer code section, and a controller configured to install the stored computer code section, the controller being further configured to initialize an activation function in which a user is prompted for identification information to begin at least one of monitoring, controlling, or receiving constraint violations of the vehicle. The network comprises at least one of a GSM/GPRS network, a SMS/GPRS network, or a GSM/WAP network. The identification information comprises a telephone number from which the vehicle is monitored or controlled.

The host comprises a gateway configured to communicate with the user apparatus and a vehicle communicator that is affixed to the vehicle, a mapper configured to monitor geospatial attributes of the vehicle communicator, and a database configured to store a user profile and geospatial data associated with the geospatial attributes of the vehicle communicator. The host further comprises a network interface configured to communicate with a terminal through the gateway over the network, a user apparatus interface configured to communicate with the user apparatus through the gateway over the network, and a setup interface configured to enable the user to configure the user apparatus based on the user profile stored in the database.

The vehicle communicator comprises a vehicle communicator location determiner configured to receive a plurality of information signals to determine a physical location of the vehicle communicator, and a network transceiver configured to communicate with the gateway over the network.

According to a further aspect of the disclosure, a method is provided for remotely managing a vehicle by monitoring, controlling, or receiving notification of constraint violations of the vehicle using vehicle managing code downloaded from a host. The method comprises receiving a target vehicle identifier for a target vehicle to be managed and a user terminal identifier associated with a user terminal from which the target vehicle will be managed, sending the target vehicle identifier and the user terminal identifier to the host, which queries a database for a status information that corresponds to the target vehicle identifier, receiving the status information from the host at the user terminal, and displaying the status information on the user terminal. The method further comprises sending a disable engine command to the host, wherein the host forwards the disable engine command to the target vehicle. In the exemplary, but non-limiting method, the user terminal comprises a mobile telephone and the user terminal identifier comprises a telephone number associated with the mobile telephone. Further, the status information comprises a constraint violation, the constraint violation being at least one of a speed violation by the target vehicle, an out of zone violation of the target vehicle, an alcohol concentration violation in the target vehicle, a vehicle occupancy violation in the target vehicle, and a vehicle load violation for the target vehicle. Moreover, the status information comprises at least one of a topographical map of the region in which the target vehicle is located, a speed of travel of the target vehicle, a direction of travel of the target vehicle, and an engine status of the target vehicle.

According to a further aspect of the disclosure, a program is provided for remotely managing a vehicle by monitoring, controlling, or receiving notification of constraint violations of the vehicle. The program is recorded on a computer readable medium. The computer readable medium comprises a target vehicle identifier code section that causes, when executed, a target vehicle identifier to be received, a user terminal identifier receiving code section that causes, when executed, a user terminal identifier to be received, the user terminal identifier being associated with a user terminal from which the target vehicle will be managed, a target information code section that causes, when executed, the sending of the target vehicle identifier and the user terminal identifier to a host, the host being configured to query a database for a status information that corresponds to the target vehicle identifier, a status information code section that causes, when executed, the status information to be received from the host at the user terminal, and a display code section that causes, when executed, the status information to be displayed on the user terminal. The user terminal comprises a mobile telephone and the user terminal identifier comprises a telephone number associated with the mobile telephone. The computer readable medium further comprises a disable engine command section that causes, when executed, sending a disable engine command to the host, the host being further configured to forward the disable engine command to the target vehicle. The status information comprises a constraint violation, the constraint violation being at least one of a speed violation by the target vehicle, an out of zone violation of the target vehicle, an alcohol concentration violation in the target vehicle, a vehicle occupancy violation in the target vehicle, and a vehicle load violation for the target vehicle. Further, the status information comprises at least one of a topographical map of the region in which the target vehicle is located, a speed of travel of the target vehicle, a direction of travel of the target vehicle, and an engine status of the target vehicle. The computer readable medium also comprises a GPRS network communication code section that causes, when executed, the mobile telephone to communicate with the host over a GPRS network.

Furthermore, the computer readable medium also comprises a network communication code section that causes, when executed, the user terminal to communicate with the host over a network, a download code section that causes, when executed, a vehicle management code section to be downloaded to the user terminal from the host over the network. The vehicle management code section comprises a profile code section that causes, when executed, a profile editing interface to be established on the user terminal, the profile editing interface being configured to receive instructions to edit a user profile, and further configured to display a profile status, a view vehicle code section that causes, when executed, a view vehicle editing interface to be established on the user terminal, the view vehicle editing interface being configured to receive instructions to edit a target vehicle and to display a status of the target vehicle, and a view action code section that causes, when executed, a view action editing interface to be established on the user terminal, the view action editing interface being configured to receive instructions to edit an action and to display a status of the action, and an install code section that causes, when executed, the downloaded management code section to be installed to the user terminal. The network comprises at least one of a GSM/GPRS network, an SMS/GPRS network, or a GSM/WAP network. The status information is received by the host from the target vehicle over the network.

### BRIEF DESCRIPTION OF THE DRAWINGS

The present disclosure is further described in the detailed description that follows, by reference to the noted drawings by way of non-limiting examples of embodiments of the present disclosure, in which like reference numerals represent similar parts throughout the several views of the drawings:

FIG. 1 illustrates an exemplary environment for implementing an embodiment of a communications system, according to an aspect of the present disclosure;

FIG. 2 is a block diagram illustrating an exemplary embodiment of an Intelligent Control System (ICS), according to an aspect of the present disclosure;

FIG. 3 is a block diagram illustrating an exemplary embodiment of a host, according to an aspect of the present disclosure;

FIG. 4 is a block diagram illustrating an exemplary embodiment of the Hand Held Unit (HHU), according to an aspect of the present disclosure;

FIG. 5 is a flow diagram illustrating an exemplary initialization process, according to an aspect of the present disclosure;

FIG. 6 is a flow diagram illustrating an exemplary process for activating a Remote Monitor and Control Communication System (RMCCS), according to an aspect of the present disclosure;

FIG. 7 is a flow diagram illustrating an exemplary setup process, according to an aspect of the present disclosure;

FIG. 8 is a flow diagram illustrating an exemplary start process, according to an aspect of the present disclosure;

FIG. 9 is a flow diagram illustrating an exemplary constraint violation detection process, according to an aspect of the present disclosure; and

FIGS. 10A and 10B is a flow diagram illustrating an exemplary intelligent communication process, according to an aspect of the present disclosure.

### DETAILED DESCRIPTION OF THE DISCLOSURE

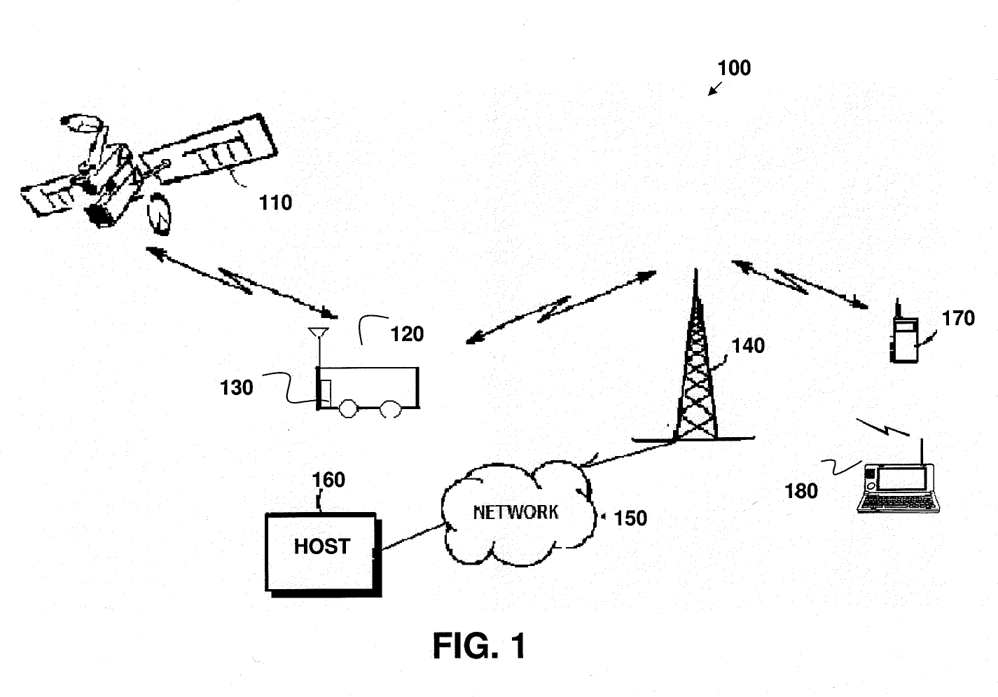

A exemplary environment for implementing an embodiment of the present disclosure is shown in FIG. 1. A Remote Monitor and Control Communication System (RMCCS) 100 is provided, which includes a satellite system 110 for broadcasting information signals that are received by an Intelligent Control Station (ICS) 130, which may be mounted in a vehicle 120. The ICS 130 communicates with a host 160 (or a hub, such as, for example, a server) via a relay station 140 and a network 150, communicating information and data such as, for example, instructions, status information, constraints and/or location data, to the host 160. The ICS 130 also communicates with a Hand-Held Unit (HHU) 170 via the relay 140. Additionally, the ICS 130 may communicate with the HHU 170 via the relay 140, the network 150 and the host 160.

According to an aspect of the disclosure, the satellite system 110 may be, for example, a constellation of three or more satellites orbiting the Earth in a medium Earth orbit, such as the Global Positioning System (GPS). The satellite system 110 sends signals in the radio frequency (RF) spectrum that are received by the ICS 130. Using known techniques such as, for example, triangulation of received signals from the satellite system 110, the ICS 130 determines the receiver's location, speed and direction.

Although depicted as a bus, it is understood that the vehicle 120 may be any mobile system or mode of transportation, including automobiles, trucks, buses, ships, aircraft, spacecraft, and the like, or any combination thereof. The vehicle 120 may be operated by a user, either locally or remotely, or it may be operated by an artificial intelligence system (such as, for example, a computer system using a neural network or fuzzy logic) that is positioned locally in the ICS 130 or vehicle 120, or positioned in some location that is remote from the ICS 130 or vehicle 120.

In the non-limiting exemplary embodiment, the relay 140 is a base station subsystem in a Global System for Mobile (GSM) communications network, which is coupled to a General Packet Radio Services (GPRS) network system 150. However, as the skilled artisan will readily appreciate, the relay 140 may be any communications system capable of communicating signals to (and from) the ICS 130, as well as communicating signals to (and from) the HHU 170, and host 160 (via network 150). Moreover, the relay 140 and the network 150 may be integrated into a single network, as is well known in the art.

In the exemplary, non-limiting embodiment of the disclosure, the network 150 is a GPRS network. The skilled artisan will readily appreciate that any network or system of networks may be used for the network 150, such as, for example, a local area network (LAN), a wide area network (WAN), a system of networks (such as, for example, the Internet), or the like.

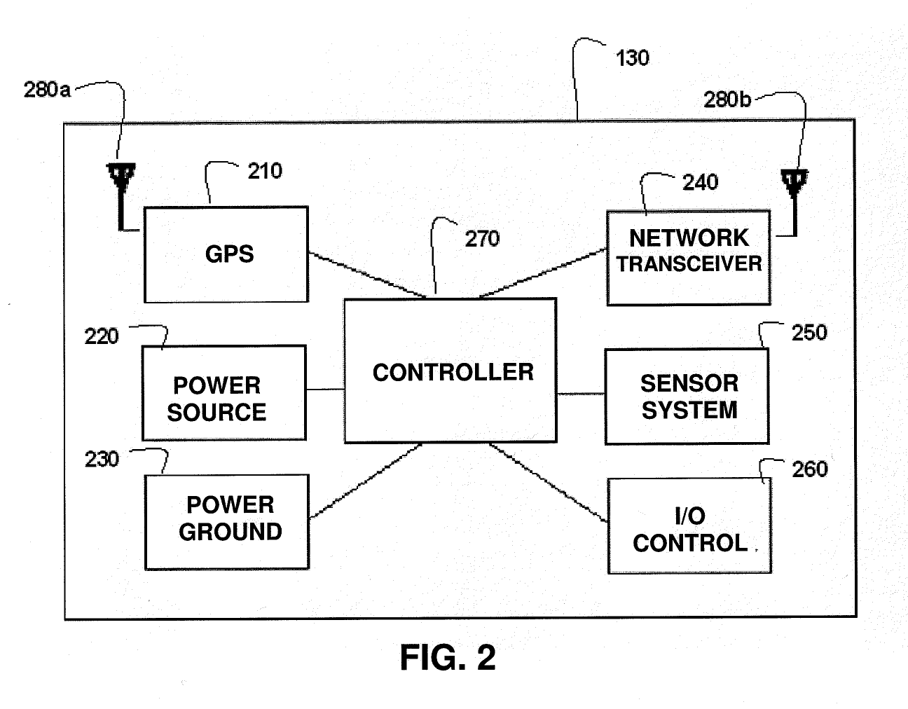

An exemplary, non-limiting embodiment of the ICS 130 is shown in FIG. 2. The ICS 130 includes a controller 270, which is connected to each of a GPS receiver 210, a power source 220, a power ground 230, a network transceiver 240, a sensor system 250, and an input/out (I/O) control 260.

The controller 270 includes a processor and a memory (not shown), as is known in the art. The controller 270 controls the processes that are carried out by the ICS 130. For example, the controller 270 communicates with the various components, which include both hardware and software components, in the ICS 130, such as, for example the GPS receiver 210, the network transceiver 240, the sensor system 250 and the I/O control 260, as well as peripheral components (not shown), which also include hardware and software components, via I/O control 260.

The controller 270 is connected to the GPS receiver 210 and the network transceiver 240, which in turn are connected to an antenna (not shown), via antennae subsystems. The GPS receiver 210 is connected to the antenna via an antenna subsystem 280a and the Network transceiver 240 is connected to the antenna via an antenna subsystem 280b. Each antenna (not shown) may be an external dedicated antenna mounted to the vehicle 120, or it may be an existing vehicle antenna that is coupled to the antenna subsystems 280a and 280b.

The GPS receiver 210 receives a plurality of RF signals over a plurality of channels via antenna subsystem 280a, including, but not limited to, latitude data, longitude data, the number of satellites, and other information from the satellite system 110. For example, the GPS receiver 210 may receive RF signals over twenty distinct channels from the satellite system 110. As the skilled artisan will readily appreciate, the GPS receiver 210 may receive any number of RF signals, without departing from the scope and/or spirit of the disclosure.

The GPS receiver 210 processes the received plurality of RF signals to generate location information associated with the physical location of the GPS receiver 210, as well as a velocity of travel information, which includes a time, magnitude and a vector component. The location information includes four dimensional location coordinates such as, for example time, latitude, longitude and altitude. The GPS receiver 210 then relays the location information and velocity information to the controller 270 using, for example, a National Marine Electronics Association (NMEA) 2000 standard, using an ASCII, serial communications protocol, or any other standard protocol capable of facilitating communication between the GPS receiver 210 and controller 270.

The network transceiver 240 is responsible for sending and receiving information through a communications network (such as, for example, a GSM network) via the relay 140. In one embodiment, the network transceiver 240 is configured to use a GPRS network standard, however, as the skilled artisan will readily appreciate, the transceiver 240 may be configured to use an SMS, a Universal Mobile Telecommunications System (UMTS), a Code Division Multiple Access (CDMA), a Time Division Multiple Access (TDMA), a TErrestrial Trunked RAdio (TETRA), a Wideband Code Division Multiple Access (W-CDMA), a Wireless Application Protocol (WAP), or any other communication standard, without departing from the scope and/or spirit of the disclosure.

The sensor system 250 includes a movement sensor, such as, for example, an accelerometer. The exemplary sensor system 250 detects movement of the ICS 130 in four dimensions, including, for example, a world coordinate system dimensions (x, y, z) and a time dimension (t). Upon movement of the vehicle 120, and thereby the ICS 130, the sensor system 250 sends a movement detection signal to the controller 270.

The sensor system 250 may include a variable threshold adjuster (not shown) that may be adjusted to set a minimum threshold value below which the sensor system 250 will not send the movement detection signal to the controller 270. Further, the variable threshold adjuster may be adjusted to set a maximum threshold value above which the sensor system will send an impact signal to the controller 270.

Alternatively, the controller 270 may include a variable threshold adjuster (not shown) that may be adjusted to set a minimum threshold value below which a received movement detection signal from the sensor system 250 will not be regarded as movement of the ICS 130, and therefore the vehicle 120. Further, the variable threshold adjuster may be adjusted to set a maximum threshold value above which a received movement detection signal from the sensor system 250 will be regarded as an impact signal from the ICS 103, and therefore the vehicle 120.

The power source 220 generally serves as a secondary power supply for the ICS 130. The ICS 130 is connected to a power supply of the vehicle 120, such as, for example, a six-volt, a twelve-volt, or a twenty-four-volt power supply found in land, marine, and aeronautical vehicles. The ICS 130 uses the vehicle's power supply as its primary power supply. The power source 220 may be a rechargeable power supply that is able to provide the ICS 130, including the controller 270, with adequate power for long periods of time, for example, when the power supply of the vehicle 120 is disconnected from the ICS 130. The power source 220 continuously charges using the power supply from the vehicle 120, and any break in the power supply from the vehicle 120 is detected by the controller 270.

The controller 270 is further connected to the power ground 230 such as, for example, the chassis of the vehicle 120, by known techniques. The power ground 230 grounds the ICS 130 to a common ground potential with the vehicle 120.

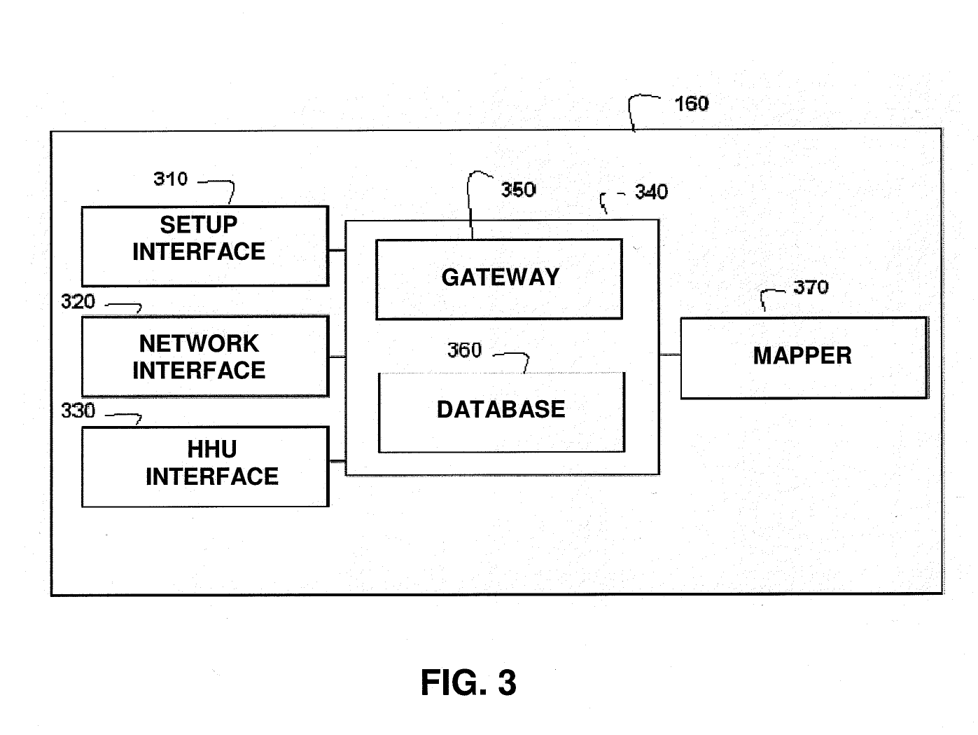

The I/O control 260 controls and enables communication between the ICS 130 and the electronic systems of the vehicle 120. Further, the I/O control 260 can be connected to peripheral components such as, for example, an ignition sensor, a temperature sensor, an ignition block (e.g., “kill” or engine disable) system, a display device, a camera, an accident detection sensor, a driver sleep detection sensor, and the like. For example, the I/O control 260 can be connected to an ignition block system to allow a user to remotely disable the engine by sending a disable engine command from the HHU 170s, which is relayed through the host 160 to the target vehicle. The I/O control 260 also controls and enables communication between the ICS 130 and the host 160, via the relay 140 and the network 150 (shown in FIG. 1). An exemplary, non-limiting embodiment of the host 160 is shown in FIG. 3.

Referring to FIG. 3, the host 160 includes a setup interface 310, a network interface 320, a hand held unit (HHU) interface 330, a host gateway controller 340, and a mapper 370. The host gateway controller 340, which includes a gateway 350 and a database 360, is connected to each of the setup interface 310, the network interface 320, the HHU interface 330, and the mapper 370, as shown in FIG. 3. Each of the setup interface 310, the network interface 320, the HHU interface 330, the gateway controller 340, the database 360, and the mapper 370 may include any combination of hardware and/or software components, as the skilled artisan will appreciate, without departing from the scope and/or spirit of the disclosure.

The setup interface 310 enables the host 160 to communicate with the user via the network 150, the relay 140 and the HHU 170 (shown in FIG. 1), allowing the user to configure the HHU 170 with setup information including, for example, one or more telephone numbers (for each of the vehicles to be managed), personal identification (PIN) numbers, one or more vehicles to be managed by the HHU 170, constraints for each of the respective vehicles, constraints for all of the vehicles, and the like.

The network interface 320 enables the host 160 to communicate with the user via the network 150, the relay 140 and a terminal 180. The network interface 320 allows the user to communicate with the host 160 using, for example, a network browser application that is executed on the terminal 180, or any other application that may be capable of facilitating communication between the user, and the host 160 over the relay 140 and network 150.

The network interface 320 is configured to send information to the user at the terminal 180, thereby enabling the user to display information regarding the vehicles, receive alerts and interact with the ICS 130 in each vehicle, by, for example, using the browser running on the terminal 180.

The HHU interface 330 enables the host 160 to communicate with the user via the network 150, the relay 140 and the HHU 170. The HHU interface 330 allows the user to perform functions such as, for example, locating one or more of the vehicles for which the user has previously provided information, disabling the one or more vehicles, remotely controlling the one or more vehicles, and the like.

The gateway 350 is configured to control and carry out communication between the host 160, the ICS 130 and the HHU 170. The gateway 350 is shown in FIG. 3 as being a part of the host gateway controller 340. However, the gateway 350 may be located external to the gateway controller 340, for example, as a peripheral component. The gateway 350 is responsible for receiving and sending communication signals between the ICS 130, the HHU 170 and the host 160.

The database 360 stores information for the gateway controller 340 and, more generally, the host 160. The database 360 stores information such as, for example, a user profile for each user, including the user's name, one or more addresses, one or more telephone numbers, one or more email addresses, and the like. The database 360 also stores further information for each user, such as, for example, one or more vehicles, one or more constraints to be controlled and/or monitored, and the like.

The mapper 370 continuously monitors geospatial attributes for each ICS 130 such as the latitude, the longitude, the altitude, the date, the local time at the ICS 130 location, the local time at the host 160, and the global time or Coordinated Universal Time (UTC). The mapper 370 communicates with the database 360 to store and retrieve the necessary data. The mapper 370 is also responsible for monitoring other geospatial attributes such as, for example, the location codes for each ICS 130, including alphanumeric characters. The location codes may include such information as continent, country, republic, state, county, city, and the like.

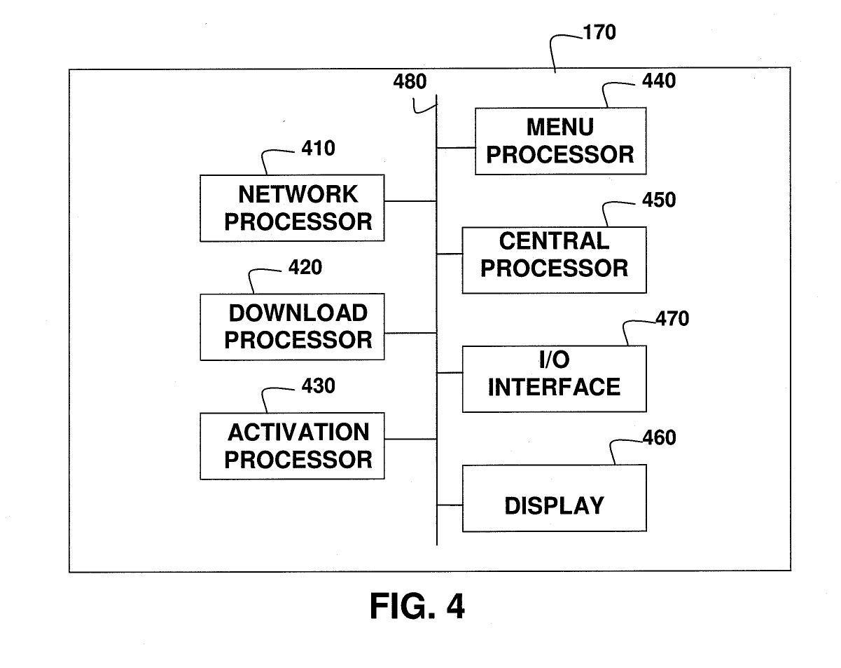

FIG. 4 shows an exemplary, non-limiting embodiment of the HHU 170 according to an aspect of the disclosure. Referring to FIG. 4, the exemplary HHU 170 includes a network processor 410, a download processor 420, an activation processor 430, a menu processor 440, a central processor 450, a display 460 and an I/O interface 470, each of which is connected to a bus 480. The network processor 410, download processor 420, activation processor 430, menu processor 440, and central processor 450 may be any combination of hardware and/or software, as the skilled artisan will readily appreciate, without departing from the scope and/or spirit of the disclosure. Also, although shown as five separate processors in FIG. 4, the network processor 410, download processor 420, activation processor 430, menu processor 440 and central processor 450 may be combined into a single processor, or any number of processors. Moreover, the processor(s) may function in an individual processing scheme, a distributive processing scheme, or an combination thereof, as is known in the art.

The network processor 410 allows the HHU 170 to communicate with the host 160, via the I/O interface 470, over the relay 140 and the network 150 (shown in FIG. 1). The network processor 410, which, in the exemplary embodiment, functions under the coordinative control of the central processor 450, activates communication over the I/O interface 470 between the HHU 170 and the HHU interface 330 (shown in FIG. 3) in the host 160. The network processor 410 may include a platform such as, for example, a Java Mobile Information Device Profile (MIDP) 1.0 sitting on top of a Connected Limited Device Configuration (CLDC) 1.0 or higher to enable communication over a GSM/GPRS network, or other network, including, for example, the public telephone network and/or the Internet. However, as the skilled artisan will readily appreciate, any other platform may be used for the network processor 410, without departing from the spirit and/or scope of the disclosure.

The download processor 420, which, in the exemplary embodiment, functions under the coordinative control of the central processor 450, controls downloading of programs and/or data to the HHU 170 through the I/O interface 470. The download processor 420 includes, for example, a GPRS or Wireless Application Protocol (WAP) platform, allowing the HHU 170 to download programs and/or data from the host 160 over the relay 140 and network 150.

The activation processor 430, which, in the exemplary embodiment, functions under the coordinative control of the central processor 450, activates initialization of the control and/or monitoring functions to be performed by the HHU 170. The activation processor 430 causes a network connection to be opened through the I/O interface 470, via the relay 140 and the network 150, to the host 160.

The menu processor 440, which functions under the coordinative control of the central processor 450, manifests information to the user by displaying alphanumeric characters, images, and/or chromic illumination on the display 460, as well as reproducing sound signals on, for example, a sound system (not shown). The alphanumeric characters may be provided for multiple languages so that a user may select the language of choice for the manifested information. For example, the alphanumeric characters may be provided in English, Portuguese, Spanish, Japanese, Korean, Chinese, French, German, etc., as desired by the user.

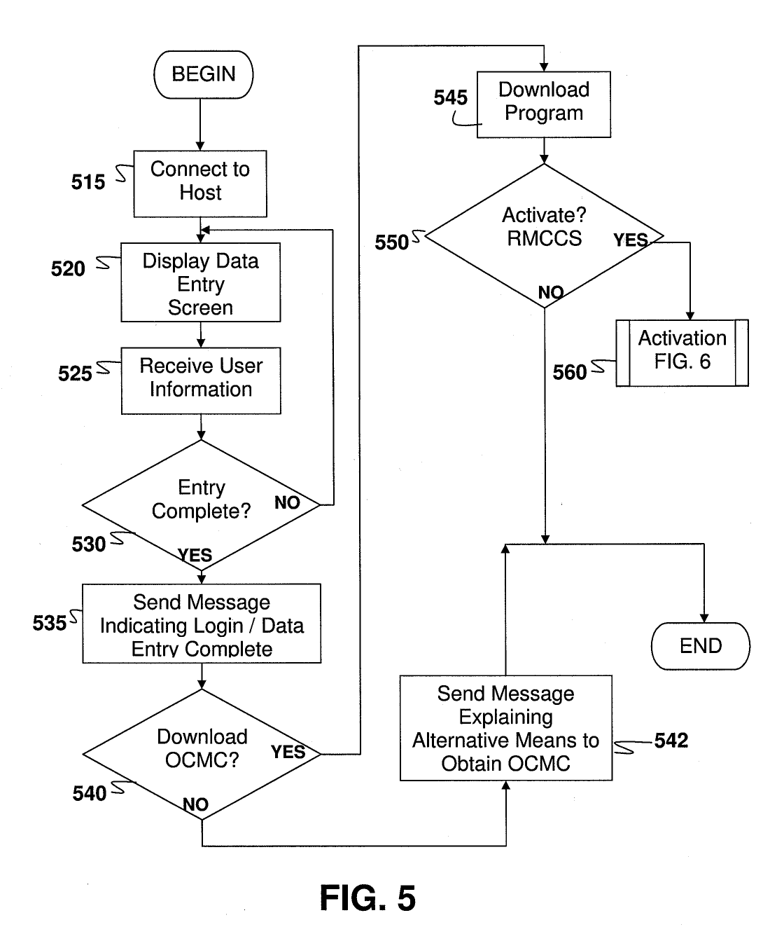

FIG. 5 shows an exemplary, non-limiting initialization process to be performed by the HHU 170 and/or the terminal 180 (shown in FIG. 1), according to an aspect of the disclosure. Although the following description is provided with regard to the HHU 170, a similar process may be carried out by the terminal 180, as the skilled artisan will readily understand.

As a preliminary matter, a user must first subscribe to the vehicle communication and control service. For example, the user may establish an account using an input on an input interface of the HHU 170, an input on the terminal 180, or a communication sent to a predetermined location via, for example, a mail service (either electronic or physical mail). The input may include, for example, an indication of a user's interest in a remote vehicle management service, a telephone number for the telephone device from which one or more target vehicles will be managed, an email address for receipt of constraint violation notifications, a physical address for receipt of constraint violation notifications, and the like.

The exemplary initialization process begins at step 515, where a connection is established between the HHU 170 and the host 160. The connection may be established at the initiation of the HHU 170 or the host 160. To connect to the host 160 from the HHU 170, for example, the user may input a URL for the host 160 using a browser on the HHU 170. Alternatively, to connect to the HHU 170 from the host 160, for example, the host 160 will open a network connection to HHU 170 using the information in the user profile, which will have been previously provided by the user.

In establishing the connection, the HHU 170 and host 160 communicate via the I/O interface 470 in the HHU 170 and the HHU interface 330 in the host 160. The communication is carried out over the relay 140 and the network 150 as is known in the art.

After a connection is established between the HHU 170 and the HHU interface 330 at step 515, a data entry screen is displayed to the user on the display 460 of the HHU 170 at step 520.

Where the user has previously provided profile information, such as, for example, by pre-registration via mail or by entering the necessary information at a website to build a user profile, the user will be prompted to input administrative login information such as, for example, a user name and password, which will have been previously provided to the user according to known user name and password delivery schemes, as is known in the art.

Alternatively, where the user is accessing the host 160 for the first time, the user will be prompted at step 520 to enter the necessary information to build a user profile. Accordingly, at step 520, the user is prompted to enter information such as, for example, the user's telephone number(s), including cellular and/or landline telephone numbers, and at least one vehicle to be managed. The vehicle information may include any combination of the vehicles Vehicle Identification Number (VIN), license plate number, title number, registration number, or any other unique identifier for the vehicle. The user is also prompted to enter one or more telephone numbers from which the user will remotely control and monitor one or more desired vehicles. Additionally, a message may be displayed to the user notifying the user of, for example, a URL that the user may access using the HHU 170 in order to control and/or monitor the one or more desired vehicles.

The user may be prompted through known methods such as, for example, displaying interactive messages on the display 460, by producing audible instructions through the sound system (not shown), or a combination of both.

The user's entries are received at step 525, which have been input by the user, for example, by using the input interface 470 on the HHU 170. The entries may be sent to the host 160 real-time upon reception. Alternatively, the entries may be buffered in the HHU 170 before sending, for example, as a file containing the user entries, to the host 160. In response to receiving the user entries from the HHU 170, the host 160 builds a user profile associated with the data.

At step 530, a determination is made as to whether the user input valid data, including login information. If the user has input valid login information (“Yes” at step 530), then the process proceeds to step 535, otherwise the process returns to step 520 where the user is prompted to input a correct user name, password, or other required information that is missing or has been incorrectly entered.

For example, where the user is providing initial information to be used to build an associated user profile as discussed above, a determination is made at step 530 as to whether the user has completed entry of the requisite information, such as, for example, the telephone numbers and one or more vehicles to be managed. In the exemplary embodiment, the determination is made by querying the user whether there are more entries to be entered, or whether the user has completed data entry. Alternatively, at step 530, the determination may include a preset number of fields that must be completed by the user, and upon completion of the data entry into the last field, the determination step 530 may determine a completion of data entry (“Yes” at step 530). If it is determined at step 530 that data entry has not be completed (“No” at step 530), the HHU 170 returns to step 520, where the user is prompted to input additional data. However, if it is determined at step 530 that data entry is complete (“Yes” at step 530), the process proceeds to step 535.

At step 535, a message is manifested to the user by, for example, displaying a visual message on the display and/or an audible message through the sound system, thereby notifying the user that data entry has been completed or that the user is logged into the system.

At step 540, the user is queried as to whether the user wishes to download an Object Control/Monitor Code (OCMC) to the HHU 170 that will enable the user to control and/or monitor at least one vehicle. If the user inputs a command to download the OCMC (“Yes” at step 540), the command is communicated to the host 160. The host 160 responds to the command with a communication including the OCMC, which is received from the host 160 over the network 150 and the relay 140 for download. At step 545, the received OCMC is downloaded into, for example, a persistent storage (not shown) and installed into the HHU 170.

If the user inputs a command not to download the OCMC (“No” at step 540), the process proceeds to step 542 and a message is manifested to the user such as, for example, displaying a message instructing the user to go to a designated Uniform Resource Locator (URL) that the user may later access via the HHU 170 or terminal 180 to download the OCMC, and/or notifying the user that instructions on how to download the OCMC have been sent to an email address on record for the user. The process then returns to step 540 to offer downloading the OCMC.

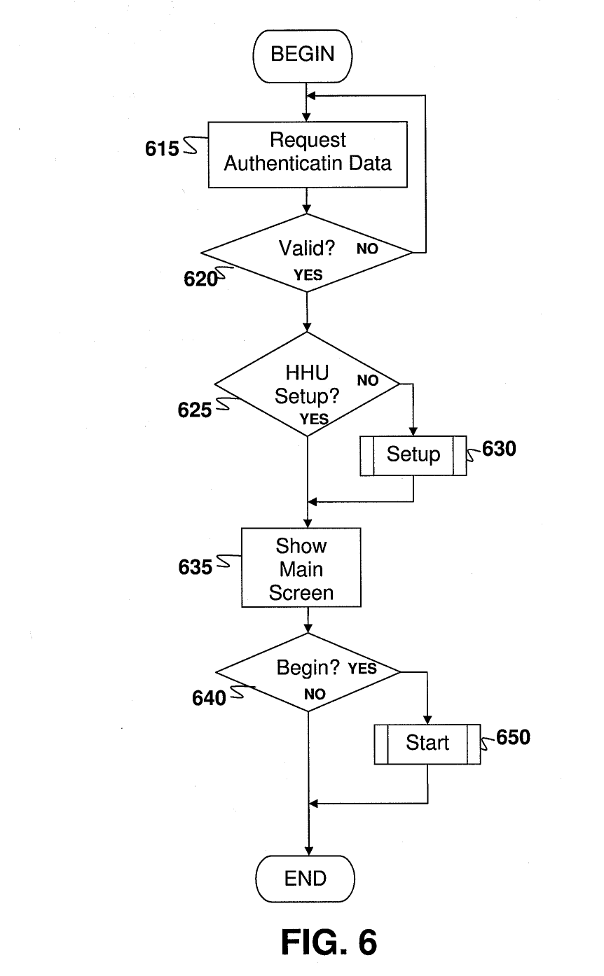

Upon completion of downloading of the OCMC into persistent storage at step 545, the OCMC is installed, the process proceeds to step 550. At step 550, the user is queried as to whether the user wishes to activate the Remote Monitor and Control Communication System (RMCCS). If the user inputs a command to activate the RMCCS (“Yes” at step 550), then the process proceeds to step 560 and initializes an activation process (an exemplary, non-limiting activation process is discussed below with reference to FIG. 6), otherwise the process ends. The RMCCS may then be activated at a later time.

As the skilled artisan will readily appreciate and understand, during the communication between the host 160 and the HHU 170 described above, the host 160 performs a process that substantially mirrors the process performed in the HHU 170, shown in FIG. 5.

Although the process for downloading and installing the OCMC into the HHU 170 is described above as being performed according to the exemplary, non-limiting process shown in FIG. 5, the OCMC may be preloaded and installed into the HHU 170 at the time of manufacture, or downloaded from a removal storage disk or flash memory, or from a peripheral device such as, for example, the terminal 180, which may have been used instead of the HHU 170 to access the host 160 and download the OCMC from the host 160.

Further, an initialization program is provided on a computer readable medium for carrying out the above discussed initialization process. As the skilled artisan will readily understand, the initialization program includes a code section for carrying out each of the steps 510 to 560 discussed above.

FIG. 6 shows an exemplary, non-limiting activation process for activating the RMCCS. Referring to FIG. 6, the activation process begins when the user instructs the HHU 170 to activate the RMCCS, for example, at step 550 in FIG. 5. Alternatively, the activation process may begin when the user inputs, for example, a URL for a website linking to the host 160. The process may also initialize when the user inputs an instruction into the HHU 170 to establish a connection with the host 160, for example, by mobile telephone communication. The skilled artisan will readily recognize and understand that any process of initializing communication between the HHU 170 and host 160 over the relay 140 and network 150 may be used without departing from the scope and/or spirit of the disclosure.

At step 615, the user is prompted to select or enter an administrative login identification (ALI) and password by, for example, displaying and/or announcing a message to the user. However, if the activation process is carried out as part of the original initialization process, an example of which was discussed with reference to FIG. 5, a status message will be displayed to the user, including the user's current ALI.

At step 620, a determination is made as to whether the ALI and password input by the user are valid. In the case where the activation process is part of the initialization process discussed above, the ALI and password will be retrieved from a temporary storage where the ALI and password were previously stored. If a determination is made that the ALI and password are not valid (“No” at step 620), then the process returns to step 615, where the user may be further instructed on how to obtain an ALI and password. When a determination is made that the ALI and password input by the user are valid (“Yes” at step 620), then the process proceeds to step 625.

At step 625, a determination is made as to whether the user has setup the user profile for the RMCCS. The determination may be made by checking the profile transaction history in the HHU 170 and/or host 160, prompting the user as to whether the user has setup the user profile, or by any other known scheme, as the skilled artisan will understand.

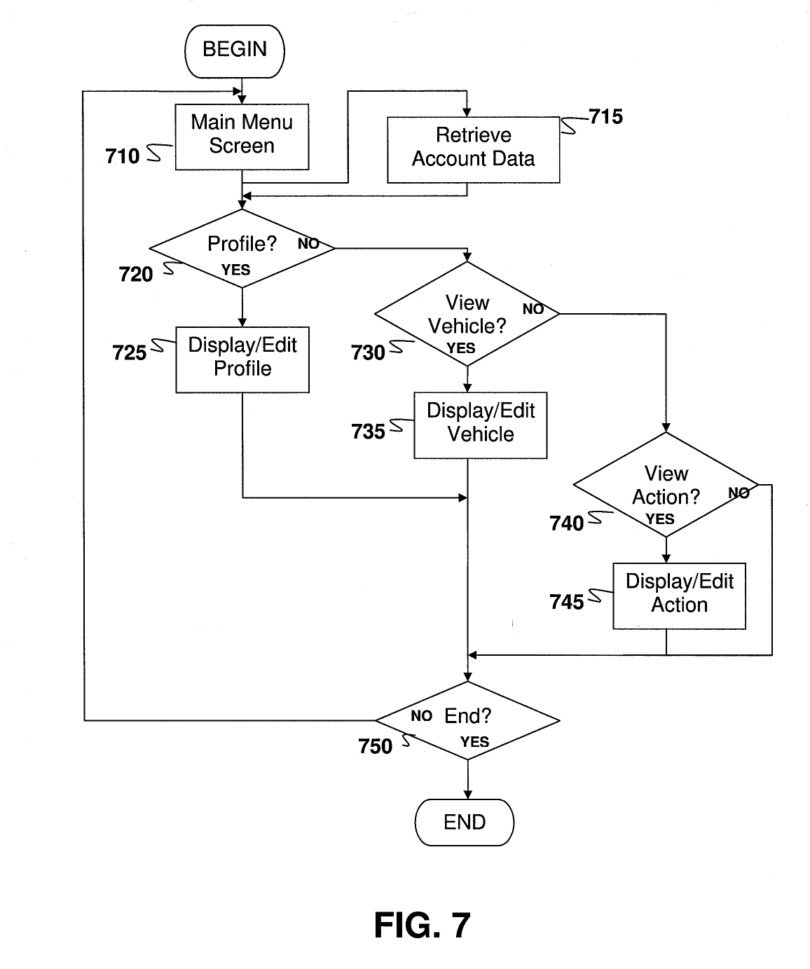

If a determination is made that the user profile has not been setup (“No” at step 625), then the process proceeds to step 630, where a setup process is carried out. An exemplary, non-limiting setup process according to an aspect of the disclosure is discussed below with reference to FIG. 7. However, if a determination is made that the user profile has been setup (“Yes” at step 625), then the process proceeds to step 635.

At step 635, a message is manifested, for example, by displaying a main screen menu or announcing a message notifying the user that the system is ready to activate the RMCCS system and prompting the user for a command to begin using the RMCCS system.

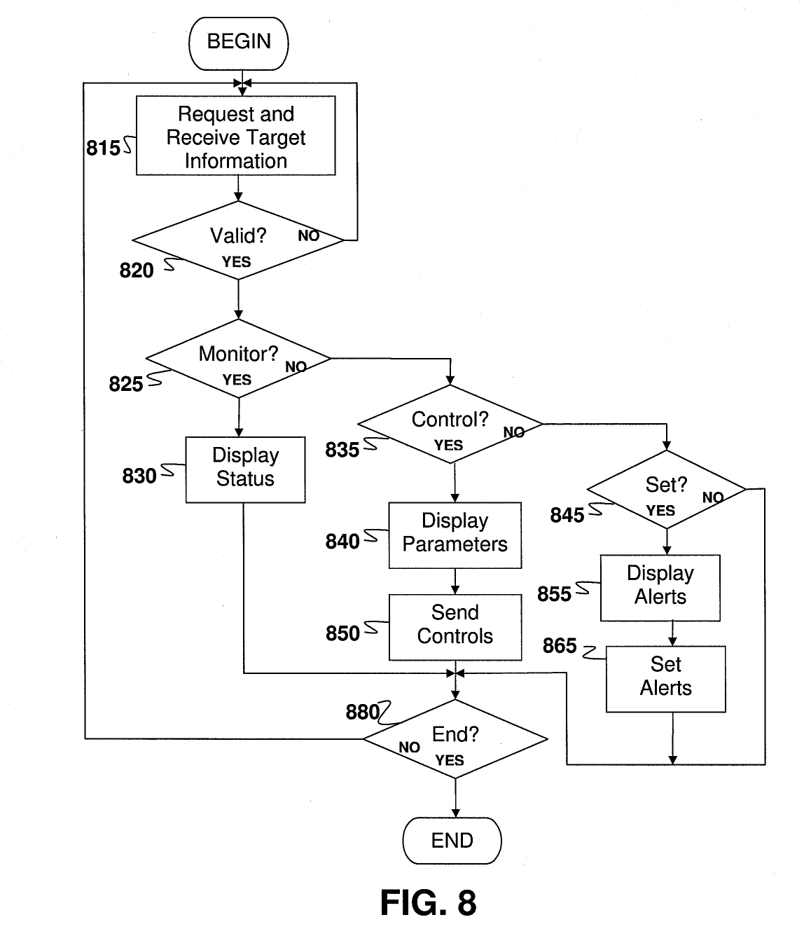

At step 640, a determination is made as to whether the user has input a command to begin using the RMCCS system. If a determination is made that the user has input a command to begin using the RMCCS (“Yes” at step 640), then the process proceeds to step 650, where a start process is carried out, otherwise the process ends (“No” at step 640). An exemplary, non-limiting setup process according to an aspect of the disclosure is discussed below with reference to FIG. 8.

Further, an activation program is provided on a computer readable medium for carrying out the above discussed activation process. As the skilled artisan will readily understand, the activation program includes a code section for carrying out each of the steps 615 to 650 discussed above.

FIG. 7 shows an exemplary, non-limiting setup process for setting up a user profile in the host 160, e.g., via the HHU 170. The skilled artisan will appreciate and understand, however, that the following exemplary process may be carried out on any one of the HHU 170, the terminal 180, or the host 160.

Referring to FIG. 7, the setup process begins by displaying a main (or root) screen on the display 460 of the HHU 170, as is known in the art, at step 710. The displayed main screen includes a list of menu options for the user to choose from. The menu options include, for example, options to view user profile, view vehicle inventory listing, view action listing, and the like.

For the purpose of simplifying the discussion, three exemplary menu options are discussed herein, including profile, vehicle and action options. However, the disclosure is not limited to these three menu options, but may include any number of menu options as the skilled artisan will readily recognize and appreciate, without departing from the scope and/or spirit of the disclosure.

At step 715, data may be downloaded from the host 160, including data such as, for example, a user profile, an inventory of vehicles, an inventory of actions, and the like, which are associated with the ALI and password. Alternatively, if the data has already been downloaded, then, at step 715, the data may be synchronized between downloaded data and corresponding data stored in the host 160 in order to ensure the up to date information in the host 160, the HHU 170 and the terminal 180.

At step 720, a determination is made as to whether the user has input a command to view a user profile that is associated with the ALI and password. If the user has input a command to view a user profile (“Yes” at step 720), then the process proceeds to step 725, otherwise the process proceeds to step 730 (“No” at step 720).

At step 725, a user profile associated with the ALI and password is displayed on, for example, the display 460 of the HHU 170. At this point in the process, the user is permitted to retain the user profile associated with the user ALI and password as it exists, or to edit the profile as is known in the art. The user profile is then saved (if edited), and the process then proceeds to step 750.

At step 730, a determination is made as to whether the user has input a command to view a vehicle associated with the ALI and password. If a determination is made that the user has input a command to view a vehicle (“Yes” at step 730), then the process proceeds to step 735, otherwise the process proceeds to step 740 (“No” at step 730).

At step 735, a vehicle, or listing of vehicles, associated with the user ALI and password is displayed to the user on the display of the HHU 170. An announced message may also be reproduced on the sound system of the HHU 170, announcing the vehicle(s) that are associated with the user's ALI and password. At this point in the process, the user is permitted to retain a series of parameters associated with the current vehicle(s), which are associated with the user's ALI and password, as well as the user's profile, as presently stored in the host 160, or to edit the parameters and/or vehicle(s). The parameters may include information such as, for example, the make and model of a vehicle, the color of the vehicle, the Vehicle Identification Number (VIN) of the vehicle, the license plate number of the vehicle, the title number of the vehicle, a telephone number associated with the vehicle, and the like.

At step 740, a determination is made as to whether the user has input a command to view at least one action associated with the user's ALI and password. If a determination is made that the user has input a command to view the at least one action associated with the user's ALI and password (“Yes” at step 740), then the process proceeds to step 745, otherwise the process proceeds to step 750.

At step 745, a listing of actions that may be controlled and/or monitored is displayed on the HHU 170. An announced message may also be reproduced on the sound system of the HHU 170, announcing the actions that may be controlled and/or monitored for each vehicle associated with the user's ALI and password. At this point in the process, the user is permitted to retain any number of actions associated with the current vehicle(s), which are associated with the user's ALI and password, as well as the user's profile. The actions may include, for example, monitoring sensor data, such as sensor devices placed inside and/or outside of the vehicle, including visible and non-visible spectrum image pickup (e.g., infrared, electromagnetic radiation, sound pickup), and chemical detection sensors (e.g., alcohol level sensors, carbon monoxide sensors, and the like). The actions may also include remotely controlling the sensor devices using the HHU 170, such as, for example, remotely controlling an image pickup field of view by using the HHU 170 and viewing the picked up image on the display of the HHU 170. Additionally, the actions may also include controlling and/or monitoring vehicle mobility, including, but not limited to, location, direction, speed, or the like, of the vehicle. The actions may also include controlling and/or monitoring a vehicle's security system, lights, locking/unlocking mechanisms, vehicle mobility, engine operation, image and/or sound pickup or generation devices, and the like. Moreover, the actions may include controlling and/or monitoring ambient conditions inside the vehicle, including, but not limited to, temperature, humidity, air quality, lighting, and the like; or, controlling and/or monitoring ambient conditions outside of the vehicle, including, but not limited to, accident detection/avoidance systems, temperature, humidity, air quality, targets, water quality, soil quality, and the like. The location, direction, and speed of the vehicle may be displayed on the display 460 of the HHU 170 in conjunction with a corresponding topographical map of the geographical region in which the vehicle is presently located.

Alternatively, at step 745, the user is permitted to edit each of the actions to be controlled and/or monitored for each vehicle associated with the user's profile, ALI and password. For example, using a user interface (UI), such as a graphic user interface (GUI), the user is permitted to change a maximum permissible speed (“speed-limiter”) for each vehicle, a geographic area of permissible operation for each vehicle, a permissible number of occupants in a vehicle, or any other action for each vehicle associated with the user's profile, ALI and password. The description of the particular process for editing the actions for each vehicle associated with the user's profile is omitted since processes for accomplishing the task are known in the art.

At step 750, a determination is made as to whether the user has input a command to end the setup process or to return to the main menu screen. When the user has input a command to end (or exit) the setup process (“Yes” at step 750), then the process ends. However, when the user has input a command to return to the main screen (“No” at step 750), then the process returns to step 710. Additionally, the process may be provided with a time-out feature that monitors activity of the user interface, which automatically ends the process or progresses the process to step 710 upon detection of a predetermined time threshold, e.g., five minutes, of user interface inactivity or no input in the HHU 170 by the user.

Although the sequence for the process of FIG. 7 is shown such that the step 720 precedes the step 730, and the step 730 precedes the step 740, the sequence is only exemplary. The skilled artisan will understand that the sequence of, for example, the steps 720, 730, or 740 may be carried out in any manner, including a parallel, simultaneous execution for all three steps of the process.

Further, a setup program may be provided on a computer readable medium for carrying out the above discussed setup process. As the skilled artisan will readily understand, the setup program includes a code section for carrying out each of the steps 710 to 755 discussed above.

FIG. 8 shows an exemplary, non-limiting start process for carrying out RMCCS system control and management, according to an aspect of the disclosure. The following exemplary process may be carried out on any one of, or a combination of, the HHU 170, the terminal 180, or the host 160. However, for the purpose of simplifying the discussion herein, the exemplary start process will be discussed with regard to the HHU 170, although as the skilled artisan will readily recognize and understand, the process is not limited to this device.

Furthermore, for the purposes of simplifying the discussion here, three exemplary functions are discussed herein, including a monitor function, a control function, and a set function. However, the disclosure is not limited to these three function options, but may include any number of additional function options as the skilled artisan will readily recognize and appreciate, without departing from the scope and/or spirit of the disclosure.

Referring to FIG. 8, the start process begins at step 815 by displaying a message on, for example, the display 460 of the HHU 170, or generated audibly on the sound system of the HHU 170, notifying the user of the system's readiness to receive target information. The target information may include for example, a vehicle identification and a target cellular telephone number. Alternatively, the message displayed or audibly reproduced may notify the user to input a vehicle identification and URL address, or any other type of identifying information that identifies a specific vehicle and a specific ICS 130 (shown FIG. 1) to be controlled and/or monitored remotely using the HHU 170.

At step 820, a determination is made as to whether the target information input by the user, including a target vehicle and a target cellular telephone number, is valid target information. When a determination is made that the target information input by the user is valid (“Yes” at step 820), then the process proceeds to step 825, otherwise the process returns to step 815 (“No” at step 820), where an error message is displayed on the HHU 170.

At step 825, a determination is made as to whether an instruction to monitor the target vehicle is input by the user. When a determination is made that an instruction to monitor the target vehicle has been input by the user (“Yes” at step 825), then the process proceeds to step 830, otherwise the process proceeds to step 835 (“No” at step 825).

At step 830, a status for each of the actions associated with the target vehicle, and previously set by the user, is displayed on the display of the HHU 170. The status may include, but is in no way limited to, a present location of the target vehicle, a direction of movement of the vehicle, a speed of travel of the target vehicle, a posted speed limit for the present location of the vehicle, the ambient conditions in the vehicle (including, for example, temperature, humidity, air quality, alcohol concentration, smoke concentration, carbon monoxide concentration, sound levels, frequencies of sound, etc.), ambient conditions outside of the vehicle, and the like. After a predetermined amount of time elapses, or in response to a command input by the user, the process proceeds to step 880.

At step 835, a determination is made as to whether an instruction to control the target vehicle is input by the user. When a determination is made that an instruction to control the target vehicle has been input by the user (“Yes” at step 835), then the process proceeds to step 840, otherwise the process proceeds to step 845 (“No” at step 835).

At step 840, each of a plurality of controllable actions associated with the target vehicle are displayed on the display 460 of the HHU 170. For example, parameters for the actions of enabling/disabling a vehicle, controlling activation/deactivation and movement (where applicable) of sensors positioned inside and/or outside of the vehicle, controlling lights inside and/or outside of the vehicle, locking/unlocking doors, opening/closing windows, controlling sound generation devices (e.g., an alarm siren, a radio, a speech synthesizer, etc.), controlling ambient conditions inside the vehicle, controlling accident detection/avoidance systems, and the like. At this point in the process, the user's commands (entries) on the user interface of the HHU 170, for example, are received and the process is progressed to step 850.

At step 850, the received commands, which the user input on the HHU 170 to control actions of the target vehicle, are processed and forwarded to the host 160, which are then processed and forwarded by the host 160 to the ICS 130, which is positioned in the target vehicle 120. Alternatively, where system response time considerations are critical, the control commands may be forwarded from the HHU 170 directly to the ICS 130 in the target vehicle 120 via existing mobile communications as is known in the art. The process then proceeds to step 880.

At step 845, a determination is made as to whether an instruction to set notification parameters associated with the target vehicle is input by the user. When a determination is made that an instruction to set notification parameters for the target vehicle has been input by the user (“Yes” at step 845), then the process proceeds to step 840, otherwise the process proceeds to step 880 (“No” at step 845).

At step 855, a listing of notification parameters associated with the target vehicle is displayed, for example, on the display 460 of the HHU 170. The notification parameters for the associated target vehicle include, for example, speed limit violation, vehicle security breach, geographic zone violation, alcohol concentration violation, hazardous conditions alert, sleepy driver alert, ICS device tampering alert, airbag activation alert, accident detection alert, and the like.

At step 865, commands (entries) input by the user to enable/disable or alter notification parameters (alerts) are received, processed and forwarded to the host 160, which are then processed and forwarded by the host 160 to the ICS 130, which is positioned in the target vehicle 120. Alternatively, as noted earlier, the user commands may be forwarded from the HHU 170 directly to the ICS 130 in the target vehicle 120 via existing mobile communications as is known in the art. The process then proceeds to step 880.

At step 880, a determination is made as to whether the user has input a command to end the start process or to return to the main menu screen. When the user inputs a command to end (or exit) the start process (“Yes” at step 880), the process ends. However, when a determination is made that the user has input a command to return to the main screen (“No” at step 880), then the process returns to step 815, where the main (or root) menu screen is displayed. Additionally, the process may be provided with a time-out feature that monitors activity of the user interface, which automatically ends the process or progresses the process to step 815 upon detection of a predetermined time threshold of user interface inactivity, for example five minutes of no input in the HHU 170 by the user.

Although the sequence of steps for the process of FIG. 8 is shown such that the step 825 precedes the step 835, and the step 835 precedes the step 845, the sequence is only exemplary. The skilled artisan will understand that the sequence of the steps 825, 835, or 845 may be carried out in any manner, including a parallel, simultaneous execution for all three steps of the process.

Further, a start program is provided on a computer readable medium for carrying out the above discussed start process. As the skilled artisan will readily understand, the start program includes a code section for carrying out each of the steps 815 to 880 discussed above.

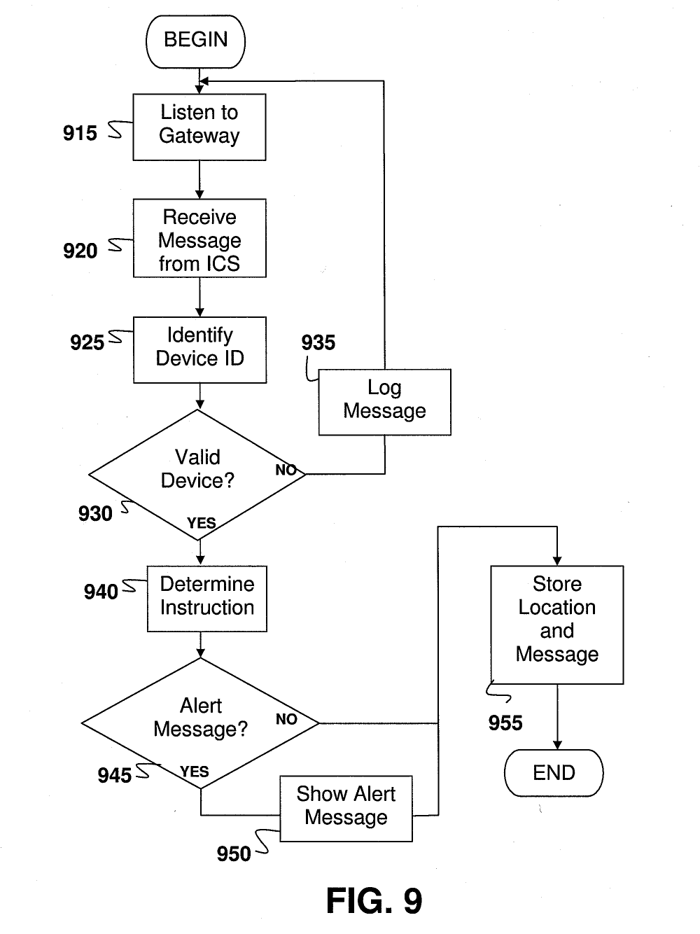

FIG. 9 shows an exemplary, non-limiting constraint violation detection process for carrying out detection of constraint violations in the RMCCS system, according to an aspect of the disclosure. The following exemplary process may be carried out on any one, or combination of the host 160, the HHU 170, or the terminal 180. However, for the purpose of simplifying the discussion herein, the exemplary constraint violation detection process will be discussed with regard to the host 160, although, as the skilled artisan will readily recognize and understand, the process is not limited to this device.

Referring to FIG. 9, the constraint violation detection process begins at step 915, in which data received on the gateway is analyzed for RMCCS packets. For example, the host 160 may listen to a mobile network via the gateway 350 (shown in FIG. 3), which may be an SMPP gateway. Upon detection of an RMCCS packet, the process depacketizes the RMCCS packets and forwards RMCCS data and proceeds to step 920.

At step 920, the RMCCS data is received and decoded, and a message is extracted from the decoded data. The message includes, for example, a vehicle identification and an ICS 130 device identification. At step 925, the vehicle identification is extracted and the vehicle which sent the RMCCS packets is identified, as is the corresponding ICS 130.

At step 930, a determination is made as to whether the received RMCCS data packets are from a valid ICS device. If a determination is made that the RMCCS packets were sent from a valid ICS device (“Yes” at step 930), then the process proceeds to step 940, otherwise the process proceeds to step 935 (“No” at step 930).

At step 935, a log message is generated, time-stamped, and logged into a database as a record. The log message includes information such as, for example, the invalid ICS device identification, the specific instructions received from the ICS device, the geographic coordinates of the ICS device, and the like. The process then returns to step 915 to listen for further RMCCS packets.

When the RMCCS data packets are from a valid ICS device, the process identifies the specific instructions contained in the message received from the valid ICS device at step 940. At step 945, a determination is made as to whether the identified instructions included in the received message include an alert message. When a determination is made that the identified instructions include an alert message (“Yes” at step 945), then the process proceeds to step 950, otherwise the process proceeds to step 955 (“No” at step 945). The alert messages may include, for example, an indication of a constraint violation, such as a geographic zone violation where a vehicle has left a specified zone, a speed violation when a vehicle has exceeded a posted speed limit, a security breach indication when a vehicle has been broken into or hit, and the like.

At step 950, the received instructions, including the alert message, are processed to determine whether the user profile associated with the valid vehicle device indicates that the associated user has requested notification for alerts of the type of alert that was included in the received instructions. When the user profile indicates that the user has requested to be notified with regard to alerts of the type that was received with the received instructions, then a message alert will be broadcast, for example, to the HHU 170 or the terminal 180 associated with the user profile for the valid vehicle device, where the alert message is displayed. The process then proceeds to step 955.

At step 955, the message received from the valid vehicle, including the instructions and the alert message, is stored in a database such as the database 360. The process then ends.

Further, a constraint violation detection program is provided on a computer readable medium for carrying out the above discussed constraint violation detection process. As the skilled artisan will readily understand, the constraint violation detection program includes a code section for carrying out each of the steps 915 to 955 discussed above.

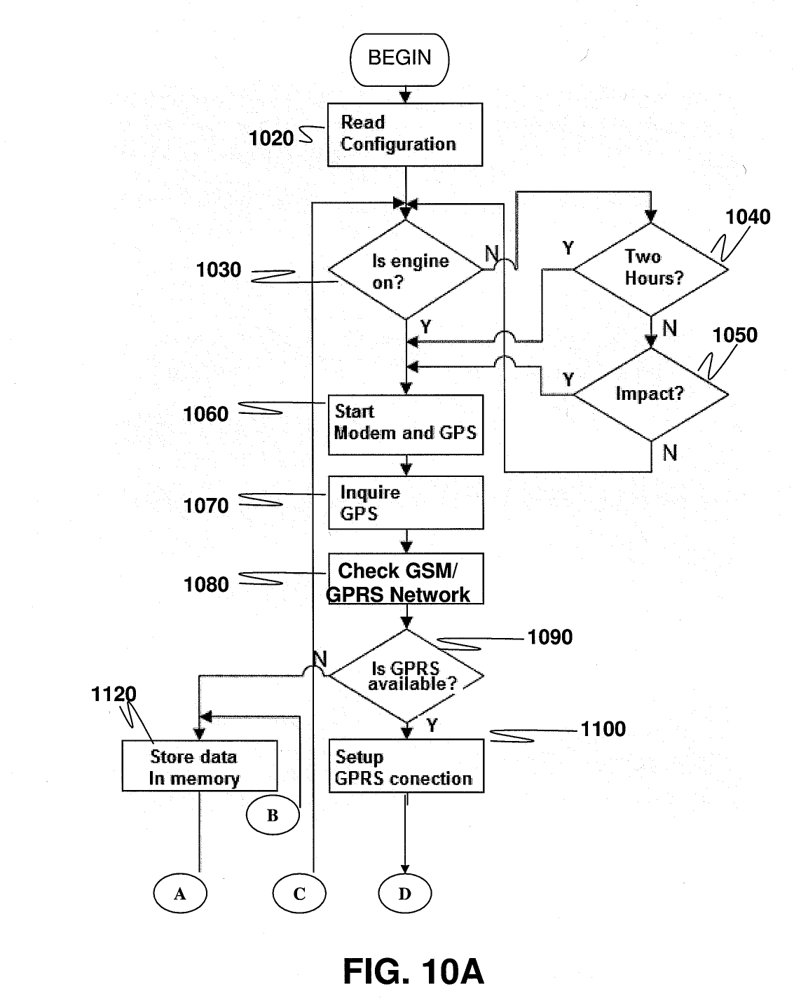

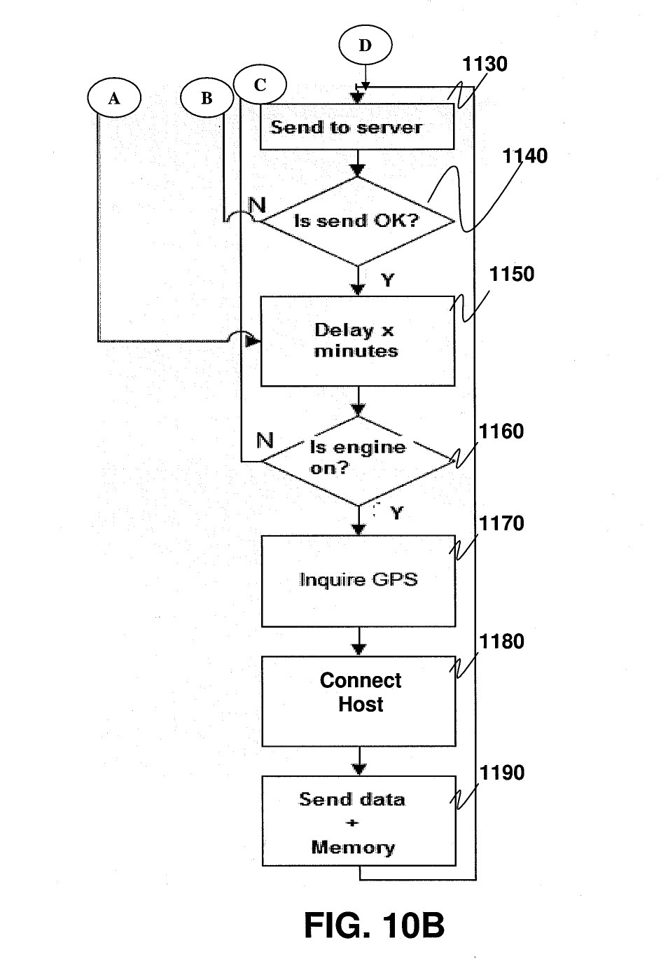

FIG. 10A and FIG. 10B show an exemplary, non-limiting intelligent communication process that may be carried out by, for example, the controller 270 in the ICS 130 (shown in FIG. 2) according to an aspect of the disclosure. At step 1020, the process reads configuration information, which may be stored locally in a memory. The configuration information includes, for example, system configuration parameters for a vehicle security system, a vehicle lighting system, a vehicle sensor system, and the like. After reading the configuration information from the memory, a determination is made as to whether the engine of the vehicle is on at step 1030,. When it is determined that the engine is not ON (“N” at step 1030), then the process proceeds to step 1040. However, when it is determined that the engine is ON (“Y” at step 1030), then the process proceeds to step 1060.

At step 1040, a determination is made as to whether a predetermined amount of time has elapsed since the last time the process was run, for example, two hours. When it is determined that the predetermined amount of time has elapsed (“Y” at step 1040), then the process proceeds to step 1060, otherwise the process proceeds to step 1050 (“N” at step 1040).

At step 1050, a determination is made as to whether a notification parameter has been triggered, for example due to an impact. When it is determined that a notification parameter has been triggered (“Y” at step 1050), then the process returns to step 1030, otherwise the process proceeds to step 1060 (“Y” at step 1050).

At step 1060 a communication transceiver 240 (e.g., a modem) and a GPS receiver are initialized. The communication transceiver 240 is initialized to enable communication over, for example, a GSM/GPRS or SMS/GPRS network. The GPS receiver 210 is initialized to receive GPS information signals from a plurality of GPS satellites.

At step 1070, the received GPS information signals are processed to determine the geographical location of the GPS receiver 210. Then, at step 1080, the process checks the available networks (e.g., a GSM/GPRS network) to determine availability of a communication channel, as is known in the art.

At step 1090, a determination is made as to whether a network is available for communication, such as a GSM/GPRS network. When it is determined that the network is available for communication (“Y” at step 1090), then the process proceeds to step 1100, otherwise the process proceeds to step 1120 (“N” at step 1090).

At step 1100, the process sets up and establishes a network connection (e.g., a GSM/GPRS network connection). Communication with the host 160 over the network is then established at step 1130. For example, a ping is sent to the host 160 in order to determine whether the host 160 is available to receive data, as is known in the art. Alternatively, a packet or datagram, including information such as the GPS coordinates of the ICS 130, may be sent to the host 160.

At step 1140, a determination is made as to whether the information sent to the host 160 was received by the host 160 by listening for a pong from the host 160. Alternatively, a confirmation packet may be received from the host 160, confirming receipt of the packet or the datagram. If the information was received at the host 160 properly (“Y” at step 1140), then the process proceeds to step 1150, otherwise the process proceeds to step 1120.

At step 1120, status information, such as engine status information determined by the process at steps 1030, elapsed time since the last time the process was carried out as determined at step 1040, impact status as determined at step 1050, location information as determined at step 1070, network health status as determined at steps 1080, 1090 and 1140, and the like, are stored, e.g., in a local memory (not shown). The process then proceeds to step 1150.

At step 1150, the process is delayed by a predetermined amount of time, for example, x minutes, where x is a positive number greater than zero. The purpose of the delay is to facilitate intermittent and discrete status update transmissions to the host 160, thereby increasing the capacity of the host 160 to communicate with additional ICS units.

At step 1160, a determination is made as to whether the engine is ON. At step 1160, if it is determined that the engine is ON (“Y” at step 1160), then the process proceeds to step 1170, otherwise the process returns to step 1030 (“N” at step 1160), discussed above.

At step 1170, the process updates GPS coordinates for the present location of the receiver and proceeds to step 1180, where the ICS 130 connects to the host 160, and sends updated status information to the host 160 and to a local memory at step 1190. The updated status information includes, but is not limited to, engine status information, elapsed time since the last time the process was carried out, impact status, location information, network health status, and the like, as mentioned earlier. The process then returns to step 1130, where additional information is sent to the host 160, including, for example, updated GPS coordinates, velocity of the ICS 130, and the like.

Further, an intelligent communication program is provided on a computer readable medium for carrying out the above discussed intelligent communication process. As the skilled artisan will readily understand, the intelligent communication program includes a code section for carrying out each of the steps 1020 to 1190 discussed above.

Although the present specification describes components and functions that may be implemented in particular embodiments with reference to particular standards and protocols, the disclosure is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope and spirit of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments that fall within the true spirit and scope of the present disclosure. Thus, to the maximum extent allowed by law, the scope of the disclosure is to be determined by the broadest permissible interpretation of the following claims and their equivalents, and shall not be restricted or limited by the foregoing detailed description.

Although several exemplary embodiments have been described, it is understood that the words that have been used are words of description and illustration, rather than words of limitation. Changes may be made within the purview of the appended claims, as presently stated and as amended, without departing from the scope and spirit of the disclosure in its aspects. Although the description refers to particular means, materials and embodiments, the disclosure is not intended to be limited to the particulars disclosed, but rather extends to all functionally equivalent structures, methods, and uses such as are within the scope of the appended claims.

For example, the disclosure is not limited to vehicles, but may, instead, be used to control and/or monitor any asset that may be moved. The disclosure may implemented to monitor cargo such as, for example, shipping containers that may be placed on ships, or packages transmitted through typical channels of delivery.

What is claimed:

1. A system for implementing remote communications with a vehicle, the system including a user apparatus and a host, the user apparatus comprising:
a communication interface configured to communicate with the host over a network and to receive a computer code section from the host;
a memory configured to store the received computer code section; and
a controller configured to install the stored computer code section, the controller being further configured to initialize an activation function in which a user is prompted for identification information to begin at least one of monitoring, controlling, or receiving constraint violations of the vehicle.

2. The system of claim 1, wherein the network comprises at least one of a GSM/GPRS network, a SMS/GPRS network, or a GSM/WAP network.

3. The system of claim 1, wherein the identification information comprises a telephone number from which the vehicle is monitored or controlled.

4. The system of claim 1, the host comprising:
a gateway configured to communicate with the user apparatus and a vehicle communicator that is affixed to the vehicle;
a mapper configured to monitor geospatial attributes of the vehicle communicator; and
a database configured to store a user profile and geospatial data associated with the geospatial attributes of the vehicle communicator.

5. The system of claim 4, the host further comprising:
a network interface configured to communicate with a terminal through said gateway over said network;
a user apparatus interface configured to communicate with the user apparatus through said gateway over said network; and
a setup interface configured to enable the user to configure the user apparatus based on the user profile stored in the database.

6. The system of claim 5, the vehicle communicator comprising:
a vehicle communicator location determiner configured to receive a plurality of information signals to determine a physical location of the vehicle communicator; and
a network transceiver configured to communicate with the gateway over the network.

7. A method for remotely managing a vehicle by monitoring, controlling, or receiving notification of constraint violations of the vehicle using vehicle managing code downloaded from a host, the method comprising:
receiving a target vehicle identifier for a target vehicle to be managed and a user terminal identifier associated with a user terminal from which the target vehicle will be managed;
sending the target vehicle identifier and the user terminal identifier to the host, which queries a database for a status information that corresponds to the target vehicle identifier;
receiving the status information from the host at the user terminal; and
displaying the status information on the user terminal.

8. The method of claim 7, wherein the user terminal comprises a mobile telephone and the user terminal identifier comprises a telephone number associated with the mobile telephone.

9. The method of claim 7, further comprising sending a disable engine command to the host, wherein the host forwards the disable engine command to the target vehicle.

10. The method of claim 7, wherein the status information comprises a constraint violation, the constraint violation being at least one of:
a speed violation by the target vehicle;
an out of zone violation of the target vehicle;
an alcohol concentration violation in the target vehicle;
a vehicle occupancy violation in the target vehicle; and
a vehicle load violation for the target vehicle.

11. The method of claim 7, wherein the status information comprises at least one of:
a topographical map of the region in which the target vehicle is located;
a speed of travel of the target vehicle;
a direction of travel of the target vehicle; and
an engine status of the target vehicle.

12. A program for remotely managing a vehicle by monitoring, controlling, or receiving notification of constraint violations of the vehicle, the program being recorded on a computer readable medium, the computer readable medium comprising:
a target vehicle identifier code section that causes, when executed, a target vehicle identifier to be received;
a user terminal identifier receiving code section that causes, when executed, a user terminal identifier to be received, the user terminal identifier being associated with a user terminal from which the target vehicle will be managed;
a target information code section that causes, when executed, the sending of the target vehicle identifier and the user terminal identifier to a host, the host being configured to query a database for a status information that corresponds to the target vehicle identifier;
a status information code section that causes, when executed, the status information to be received from the host at the user terminal; and
a display code section that causes, when executed, the status information to be displayed on said user terminal.

13. The computer readable medium of claim 12, wherein the user terminal comprises a mobile telephone and the user terminal identifier comprises a telephone number associated with the mobile telephone.

14. The computer readable medium of claim 13, further comprising:
a disable engine command section that causes, when executed, sending a disable engine command to the host, the host being further configured to forward the disable engine command to the target vehicle.

15. The computer readable medium of claim 13, wherein the status information comprises a constraint violation, the constraint violation being at least one of:
a speed violation by the target vehicle;
an out of zone violation of the target vehicle;
an alcohol concentration violation in the target vehicle;
a vehicle occupancy violation in the target vehicle; and
a vehicle load violation for the target vehicle.

16. The computer readable medium of claim 13, wherein the status information comprises at least one of:
a topographical map of the region in which the target vehicle is located;
a speed of travel of the target vehicle;
a direction of travel of the target vehicle; and
an engine status of the target vehicle.

17. The computer readable medium of claim 13, further comprising a GPRS network communication code section that causes, when executed, the mobile telephone to communicate with the host over a GPRS network.

18. The computer readable medium of claim 12, the computer readable medium further comprising:
a network communication code section that causes, when executed, the user terminal to communicate with the host over a network;
a download code section that causes, when executed, a vehicle management code section to be downloaded to the user terminal from the host over the network, the vehicle management code section comprising:
a profile code section that causes, when executed, a profile editing interface to be established on the user terminal, the profile editing interface being configured to receive instructions to edit a user profile, and further configured to display a profile status,
a view vehicle code section that causes, when executed, a view vehicle editing interface to be established on the user terminal, the view vehicle editing interface being configured to receive instructions to edit a target vehicle and to display a status of the target vehicle, and
a view action code section that causes, when executed, a view action editing interface to be established on the user terminal, the view action editing interface being configured to receive instructions to edit an action and to display a status of the action; and
an install code section that causes, when executed, the downloaded management code section to be installed to said user terminal.

19. The computer readable medium of claim 18, wherein the network comprises at least one of a GSM/GPRS network, an SMS/GPRS network, or a GSM/WAP network.

20. The computer readable medium of claim 19, wherein the status information is received by the host from the target vehicle over said network.
